(19) United States
(12) Patent Application Publication
(10) Pub. No.: US 2021/0201387 A1
(43) Pub. Date: Jul. 1, 2021

(54) DISPLAY DEVICE, MOBILE TERMINAL, CONTROL METHOD, STORAGE MEDIUM, AND GUIDE SYSTEM

(71) Applicant: Fast Retailing Co., Ltd., Yamaguchi-Shi (JP)

(72) Inventors: Jun Hirata, Yamaguchi (JP); Tong Liu, Yamaguchi (JP)

(73) Assignee: Fast Retailing Co., Ltd., Yamaguchi-Shi (JP)

(21) Appl. No.: 17/133,003

(22) Filed: Dec. 23, 2020

(30) Foreign Application Priority Data
Dec. 26, 2019 (JP) 2019237038

(51) Int. Cl. G06Q 30/06; G06Q 20/18

(52) U.S. Cl. CPC G06Q 30/0643; G06Q 20/18; G06Q 20/322; G06Q 30/0627; G06Q 30/0639

(57) ABSTRACT

A display device that displays position information of a product on a basis of identification information including color information. and size information of the product, the identification information being information of each product, and position information of a tag from which the identification information has been read. The display device includes: as acceptance unit that accepts designation of a product from a user; an acquisition unit that acquires position information associated with identification information of the product, designation of which by the user has been accepted by the acceptance unit; and a display control unit that displays a floor map and a position corresponding to the position information acquired by the acquisition unit on the floor map in an identifiable manner in accordance with designation from the user.

### BACKGROUND

In clothing stores and the like, various clothing items are displayed as products in stores. Compared to products in other fields, clothing has a shorter cycle, and products is demand vary depending on the weather, and thus it is necessary to frequently change the layout in stores. For this reason, it is difficult for a consumer to find a desired product in a store, and there are cases where even a clerk has difficulty in grasping the display positions of products.

JP 2011-198188 A discloses an article retrieval system is which the position of a retrieval object article is displayed on a display unit by inputting the name of the retrieval object article to a retrieval device. Meanwhile, JP 2007-316897 A discloses technology for guiding a user to the position of a specific product by acquiring position information. of each product is advance by RFID scanning and also position information of the user who is operating a smartphone.

### SUMMARY

According to some embodiments of the present invention, in a display device that displays position information of a product on a basis of identification information including color information and size information of the product, the identification information being information of each product, and position information of a tag from which the identification information has been read, designation of a product by a. user is accepted, and position information that is associated with identification information. of the product, designation of which by the user has been accepted, is acquired.

Moreover, a floor map and a position corresponding to the position information on the floor map are displayed in an identifiable manner in accordance with designation from the user.

Further features of the present disclosure will become apparent from the following description of exemplary embodiments (with reference to the attached drawings).

### BRIEF DESCRIPTION OF THE DRAWINGS

FIG. 1 is a schematic diagram illustrating the configuration of a guide system including a display device;

FIG. 2 is a block diagram illustrating the hardware configuration of the display device;

FIG. 3A is a schematic view illustrating the appearance of a reading device; FIG. 3B is a block diagram illustrating a functional configuration of the reading device; FIG. 3C is a flow chart illustrating an outline of the processing flow of the reading device;

FIG. 4 is a flow chart illustrating an example of processing in a server;

FIG. 5 is a flow chart illustrating an example of processing in the display device;

FIG. 6A is a schematic diagram illustrating an example of a product designation screen displayed on a display; FIG. 6B is a schematic diagram illustrating an example of an advertisement screen displayed on a terminal owned by a user;

FIG. 7A is a schematic view illustrating an example of a floor map illustrating product positions; FIG. 7B is a schematic view illustrating an example of a product details screen; FIG. 7C is a schematic view illustrating an example of a floor map including inventory information of a selected product;

FIG. 8A. is a schematic view illustrating a usage state of a transmitter according to a second embodiment; FIG. 8B is a schematic diagram illustrating the configuration of a guide system including the transmitter; and

FIG. 9 is a flow chart illustrating an example of processing in the transmitter.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### First Embodiment

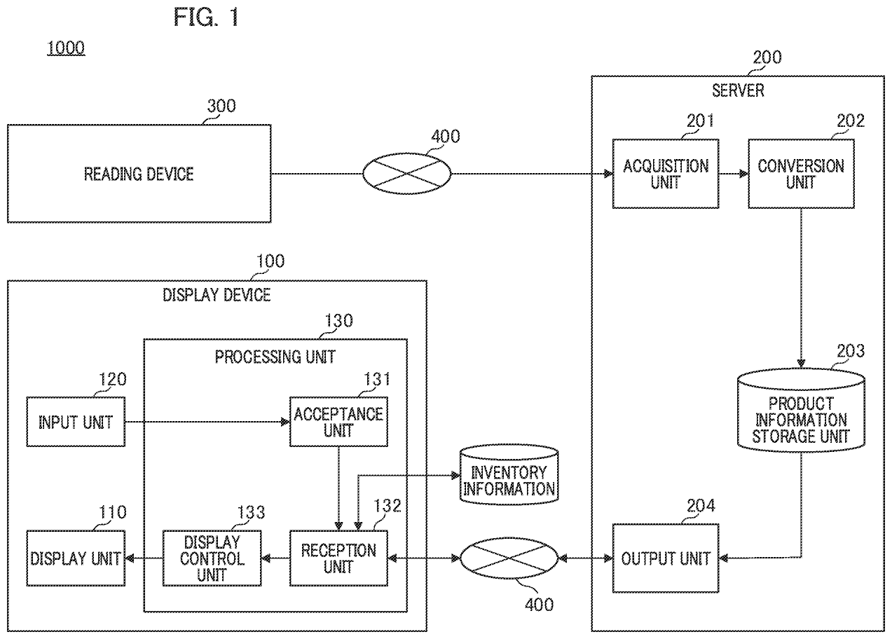

FIG. 1 is a schematic diagram. illustrating the configuration of a guide system 1000 including a display device 100. The guide system. 1000 includes the display device 100, a server 200, and a reading device 300. These devices are communicably connected by a network 400. The network 400 includes, for example, a wireless base station, a provider device, and a dedicated line of, for example, the Internet, a wide area network (WAN), a local area network (LAN), or WiFi. The guide system 1000 guides a user to a product position by acquiring product positions by scanning tags attached to each of products in a store by the reading device 300 and causing the display device 100 to display the position information corresponding to the product designated by the user.

The display device 100 is, for example, a display (signage device) installed in or outside a clothing store, a smartphone, a tablet terminal, a laptop personal computer (PC), a desktop PC, a mobile phone, or the like. Note that, in the present specification, the term “mobile terminal” refers to an information processing device that can be carried by a user such as a smartphone, a tablet terminal, a laptop PC, or a mobile phone. The display device 100 includes a display unit 110, an input unit 120, and a processing unit 130.

The display unit 110 is, for example, a liquid crystal display panel, a plasma display panel, or an organic EL display panel and is controlled by the processing unit 130. The display unit 110 displays an image under the control of the processing unit 130.

The input unit 120 is, for example, a touch panel, a keyboard, or a mouse that receives operation input from a user and receives an instructions or input from the user by the touch panel or the keys. Note that the input unit 120 may also function as the display unit 110 and that the display unit 110 and the input unit 120 may be integrated in cases such as that the display device 100 is a signage device, a smartphone, or the like. For example, the user designates a product using the input unit 120.

The processing unit 130 includes an acceptance unit 131, a reception unit 132, and a display control unit 133. The acceptance unit 131 accepts designation of a product from a user. The reception unit 132 acquires position information associated with identification information of the product, designation of which by the user has been accepted by the acceptance unit 131, from the server 200. In addition, inventory information of the designated product in a target shop is acquired from, for example, a database for managing the product inventory at each store. The display control unit 133 causes the display unit 110 to display a floor map in accordance with designation from the user. The display control unit 133 also causes a point corresponding to the position information received by the reception unit 132 to be displayed on the floor map in an identifiable manner.

The server 200 includes an acquisition unit 201, a conversion unit 202, a product information storage unit 203, and an output unit 204. The acquisition unit 201 acquires identification information of each of products read from tags attached to the products and position information of the tags by the reading device 300. Here, note that identification information of products includes at least color information and size information of products. Of course, the size and color may be replaced with corresponding information (such as numerical values). For example, “S, M, L” may be replaced with “1, 2, 3”, respectively, or colors of “white, black, yellow” may be replaced with “00, 09, 45”, respectively, for example. Meanwhile, the tags are capable of recording identification information of products, such as RFID tags. For example in a case where a tag supports RFID, the tag includes an antenna and a chip for storing identification information inside the tag and is attached to a package or fixed to a part of the product with a member called LOX. When a radio wave of a UHF band reader and writer is received from the outside by the antenna in the tag, an electric wave is generated, and the information held in an IC is output to the outside by a similar UHF band radio wave. The conversion unit 202 converts the identification information acquired by the acquisition unit 201 and the position information of the tag into position information (display position information) to be reflected on the floor map of the store. The product information storage unit 203 stores the display position information converted by the conversion unit 202 in association with the identification information. Here, the product information storage unit 203 may further store the display position information in association with floor identification information for identifying which floor of which store. The output unit 204 outputs position information corresponding to identification information of a product designated by the user in the display device 100 to the display device 100. Note that as for displays installed inside and outside the store, floor identification information suitable for the displays may be set in advance. In that case, the display device 100 outputs both the set floor identification information and identification information of a product designated by the user to the server 200 and acquires display position information of the desired product in the store from the server 200.

The reading device 300 acquires identification. information of products from the tags attached to the products displayed in the store. The reading device 300 also estimates the positions of the products for which the identification information has been acquired (practically, the position of the tags attached to the product) and outputs the positions to the server 200 together with the identification information.

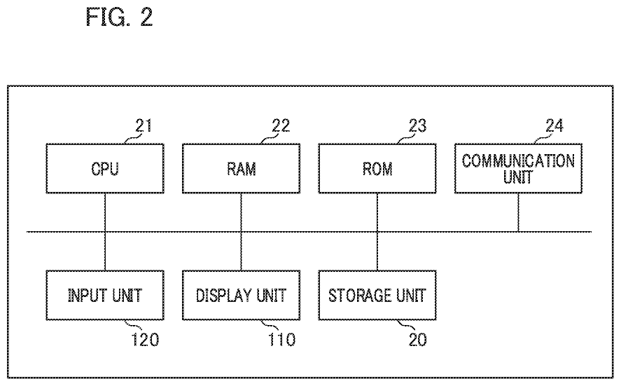

FIG. 2 is a block diagram illustrating the hardware configuration of the display device 100. The display device 100 includes a storage unit 20, a CPU 21, a RAM 22, a ROM 23, a communication unit 24, a display unit 110, and an input unit 120.

The storage unit 20 stores, for example, a program that implements a flow described later by being executed by the CPU 21 and data used by this program.

The CPU 21 operates based on a program stored in the ROM 23 or the storage unit 20 and controls the units of the display device 100. The ROM 23 stores, for example, a boot program executed by the CPU 21 at the time of activation of the display device 100 or a program. dependent on the hardware of the display device 100. The CPU 21 expands the program in the RCM 23 on the RAM 22, and the CPU 21 executes the expanded program to implement the flow which will be described later. Note that the CPU 21 may acquire these programs from another device via the network 400 and execute the programs or may directly execute the programs stored in the ROM 23.

The communication unit 24 receives data from another device via the network 400 and sends it to the CPU 21, and transmits the data or instructions generated by the CPU 21 to another device via the network 400. Note that the server 200, the reading device 300, and an inventory information database 500 each have a similar configuration to that in FIG. 2; however, detailed description thereof will be omitted.

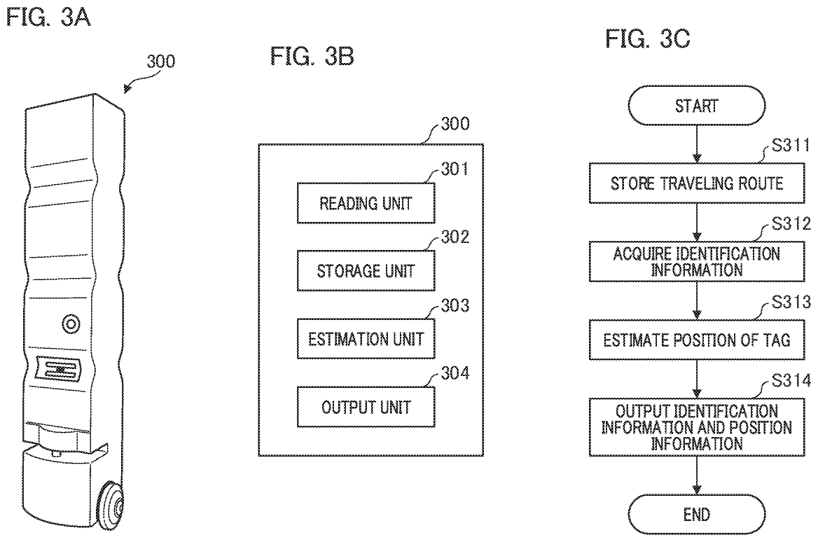

FIGS. 3A to 3C are diagrams for explaining the reading device 300. FIG. 3A is a schematic view illustrating the appearance of the reading device 300. The reading device 300 is, for example, a self-propelled type and acquires identification information of products from the tags of the products displayed in the store by traveling in the store.

FIG. 3B is a configuration diagram illustrating the configuration of the reading device 300. The reading device 300 includes a reading unit 301, a storage unit 302, an estimation unit 303, and an output unit 304. The reading unit 301 includes a plurality of antennas, reads identification information of a product from the tag of the product, and acquires the position of the tag relative to the reading device 300 by the plurality of antennas. The reading unit 301 may include only one antenna although the reading resolution or accuracy is reduced. In the configuration illustrated in FIG. 3A, the reading accuracy in the height direction is also improved by including a plurality of antenna sets in the height direction. The storage unit 302 stores, for example, a travel route in the store for reading and acquiring identification information from product tags, which is set in advance by the administrator of the reading device. The storage unit 302 stores the read identification information and further stores at which position (host device position) in the traveling route the identification information has been read.

The estimation unit 303 estimates the position (coordinates) in the store of a tag from which identification information has been read on the basis of which position (host device position) in the traveling route the identification information has been read. Here, the position (tag position) of the tag in the store is indicated by, for example, XYZ coordinates. That is, the estimation unit 303 estimates the positions of the tag in the store in the plane direction and the height direction.

The output unit 304 associates the identification information with the tag position estimated by the estimation unit 303 and outputs the identification information to the server 200.

FIG. 3C is a flow chart illustrating an output process of identification information in the reading device 300. In S311 the storage unit 302 is set with and stores a traveling route in the store by the administrator. In S312, the reading device 300 travels in the store along the traveling route stored in the storage unit 302 and acquires identification information from the tags of products displayed in the store by the reading unit 301. Then, the reading device 300 stores the read identification information and the positions where the identification information has been read in the storage unit 302. Next, in S313, the estimation unit 303 estimates the position in the store of a tag from which each piece of identification information has been read on the basis of which position in the traveling route the identification information has been read. Then, in S314, the output unit 304 associates the identification information with the position in the store of the tag estimated by the estimation unit 303 and outputs the position to the server 200.

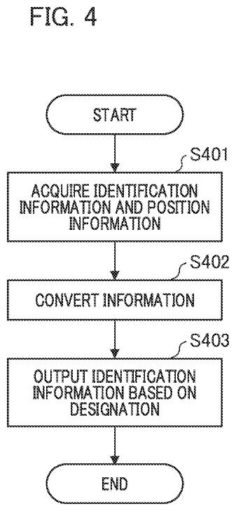

Next, the processing in the server 200 will be described with reference to the flow chart of FIG. 4. FIG. 4 is a flow chart illustrating an example of the processing in the server 200. First, in S401, the acquisition unit 201 acquires identification information of a tag and position information of the tag in the store from the reading device 300. Next, in S402, the conversion unit 202 converts the position information of the tag into information that can be reflected on a floor map of the store (display position information), associates the information with the identification information acquired by the acquisition unit 201, and stores the information in the product information storage unit 203. Then in S403, the output unit 204 outputs position information corresponding to identification information of a designated product to the display device 100 in accordance with the designation by the user in the display device 100 (details will be described later). Note that the server 200 retains layout information that indicates the outline of the layout in each store. The layout information includes the location of the store (including the country name and the store name), a store number, the store type, image data (pdf format or jpeg format) as a map that outlines the arrangement of walls or fixtures (racks) in the store or the position of pillars, and the position information and the orientation of the display device in the store. Then, in S403, the output unit 204 outputs maps corresponding to floors of the inquired store and related information (including the position and the orientation of the display device) to the display device 100.

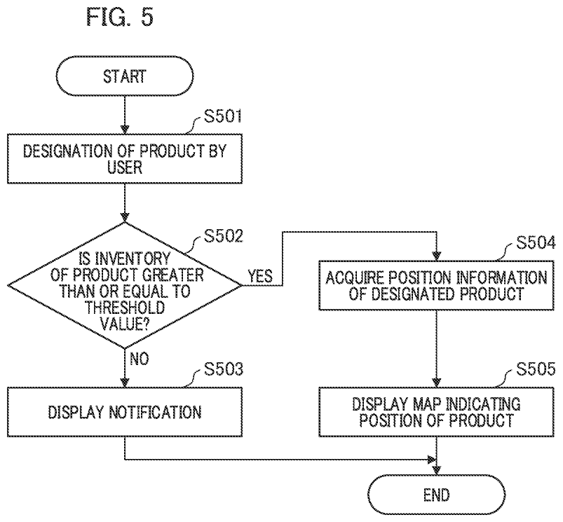

Next, the processing in the display device 100 will be described with reference to the flow chart of FIG. 5. FIG. 5 is a flow chart illustrating an example of processing in the display device 100. In S501, a user designates a product. For example, the uses designates the product from candidates displayed on the display device 100 using the input unit 120. Alternatively, for example in a case where the display device 100 is a smartphone or the like including a camera, a product may be designated by photographing and recognizing identification display (two-dimensional code, bar code, etc.) of the tag of the product in the store by the camera. Designation may be performed by extracting the product name, the color, and the size by an optical character reading device (OCR). Note that “designation of a product” by a user refers to selecting at least one or more products from multiple products and further specifying the size and color thereof. Here, the timing of selecting the product and specifying the size and color may be different or simultaneous. For example, the user interface displayed on the display device 100 may be used to accept interactively as necessary, or selecting a product and specifying the size and color may be performed simultaneously by reading specific identification information including information indicating the size and color. Alternatively, designation may be performed by selecting, on a terminal owned by a user such as a smartphone, a product published in a message such as an advertisement transmitted to the terminal. In this case, for designating the color and size, the color and size published in the advertisement may be automatically designated, or the color and size may be designated after the user selects the product on the terminal. The acceptance unit 131 accepts the designation performed in this manner.

In S502, the reception unit 132 receives inventory information of products in the store from, for example, a database for managing products in the store. Note that the inventory information of products in the store may be stored in the server 200. In S502, if the number of stocks of the product are less than or equal to a threshold value (No), the display control unit 133 causes the display unit 110 to display notifications such as “please contact the staff” or “out of stock in the store” (S503). On the other hand, if the number of stocks of the product are greater than or equal to the threshold value (Yes) in S502, the reception unit 132 receives position information associated with identification information of the designated product from the server 200 (S504). Then, in S505, the display control unit 133 displays the floor map on the display unit 110 and displays a portion on the floor map that corresponds to position information of the product received by the reception unit 132 in an identifiable manner. By not displaying when stocks of the product is less than or equal to the threshold value, it becomes possible to prevent the display device 100 from displaying a product that is worn by mannequins, for example, by not displaying an item having an inventory of three or less articles and limiting the number of articles of the item to be worn by the mannequins to three. Note that, for example in a case where the display device 100 is a signage device in this case and the display device 100 has information related to the installation position of the display device 100 in the store, it is preferable to display the installation position of the display device 100 and the display orientation of the screen on the floor map in an identifiable manner. Displaying in this manner allows the user to grasp the current location, and it becomes easier to grasp the position of the products.

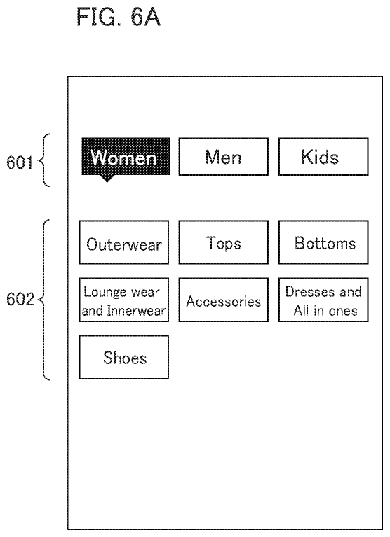

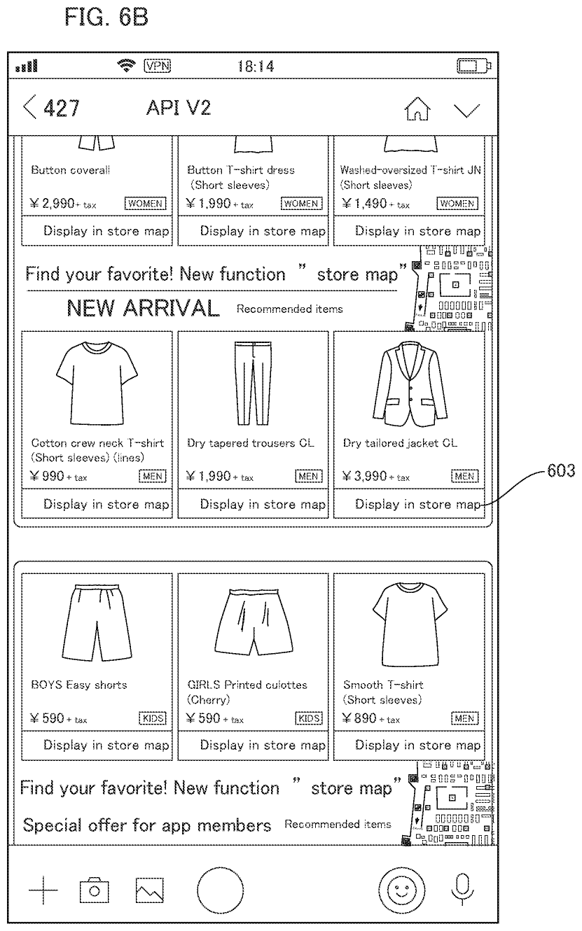

FIGS. 6A and 6B are schematic diagrams illustrating an example of a product designation screen. FIG. 6A is a schematic diagram illustrating an example of a product designation screen displayed on a display. Icons 601 are used to select a product category (major category) such as women's clothing (Women), men's clothing (Men), and children's clothing (Kids). This diagram illustrates an example in which women's clothing is selected. Icons 602 are used to select a specific category (middle category) under the category selected by the icon 601 such as outerwear, tops, bottoms, lounge wear and innerwear, accessories, dresses and all in ones, or shoes. When the user selects a desired category from the icons 602, a list of products corresponding to the category is displayed. Then, by selecting a desired product from the displayed list of products, the product is designated. Incidentally, after selecting the middle category, more specific categories (small categories) under the middle category may be further displayed. According to such a designation method of products, it is easy for the user to select a desired product.

FIG. 6B is a schematic diagram illustrating an example of an advertisement screen displayed on a terminal owned by a user. The user designates a product by selecting a product published in the advertisement on the terminal. When designating a product from the advertisement, the user can intuitively select the product. For example when the user taps a button 603 to display an in-store map (floor map), the position of the product in the store is displayed on the floor map in an identifiable mariner on the basis of link information associated with the tapped button 603.

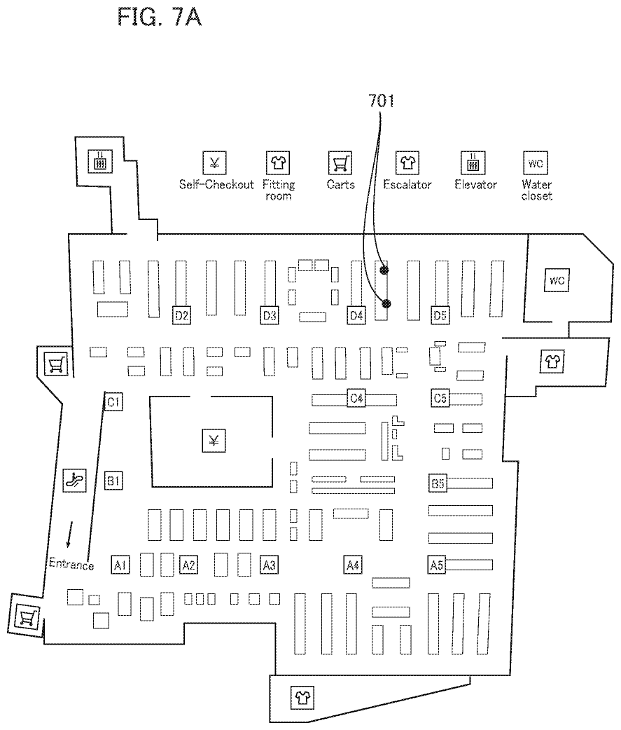

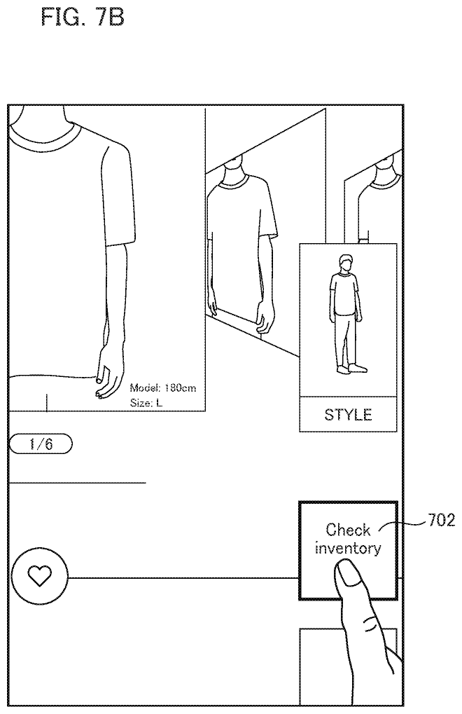

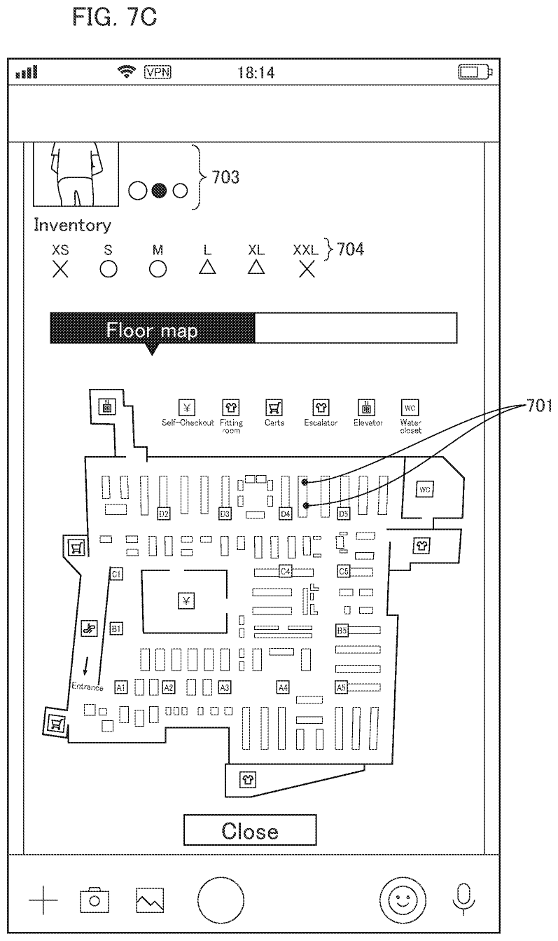

FIGS. 7A to 7C are schematic diagrams illustrating examples of display screens. FIG. 7A is a schematic view illustrating an example of a floor map illustrating product positions. In a case where the product designated by the user is in stock, the position of the designated product in the store is displayed on the floor map in an identifiable manner. In these diagrams, an icon 701 indicates the position of a designated product. It is preferable that the icon 701 is highlighted on the floor map by, for example, a highlighted color, a framed display, or blinking. Displaying the product position on the floor map in this manner allows the user to accurately and smoothly find the desired product.

FIG. 7B is a schematic view illustrating an example of a product details screen. For example, when a product is selected, a screen illustrating the details of the product may be displayed after the product is selected. The product details screen contains, for example, information of available sizes and colors of the selected product. In addition, an icon 702 for checking the inventory is displayed on the product details screen. For example, the user taps the icon 702 to display a floor map containing inventory information of the designated product.

FIG. 7C is a schematic view illustrating an example of the floor map including inventory information of the selected product. The floor map in this diagram also displays information of available sizes and colors of the selected product. In addition, the inventory status of each size is also displayed. The inventory status is displayed in such a manner as, for example, marked with x indicating that the product is out of stock when three or less articles are in stock, marked with Δ indicating that a few are in stock when four to five articles are in stock, and marked with o indicating that there are enough articles in stock when six or more articles are in stock. Furthermore, in a case where a floor map is displayed as the one illustrated in this diagram, a user can specify the size and color on the screen after selecting a product. For example, when the user selects a desired color from the icon 703 indicating color information, the inventory status of each size of the selected color and the product position are displayed on the screen. Meanwhile, a desired size may be selected from an icon 704 indicating size information without selecting the color. In this case, among the icons 703 indicating the color information, it is displayed to indicate that the product is out of stock for example by displaying diagonal lines for a color that is out of stock.

As described above, according to the present embodiment, a desired product can be accurately and smoothly found in a store such as a clothing store.

### Second Embodiment

In the present embodiment, a mode will be described in which a smartphone of a customer approaching a store is detected and notification is sent to the smartphone notifying that the display illustrated in FIG. 6B can be displayed. Note that the same symbol is given to a configuration or a process having the same function as that in the first embodiment, and description thereof will be omitted for those having the same configuration or function.

The first embodiment is pull-type technology, that is, a mechanism in which a message is delivered after a client makes a request to a server, whereas a second embodiment is push-type technology, which is a mechanism in which a preset server delivers a message to a client in accordance with a predetermined condition.

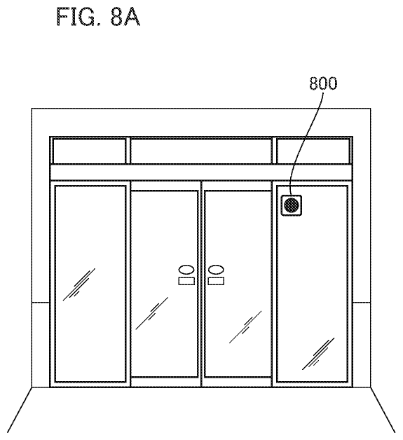

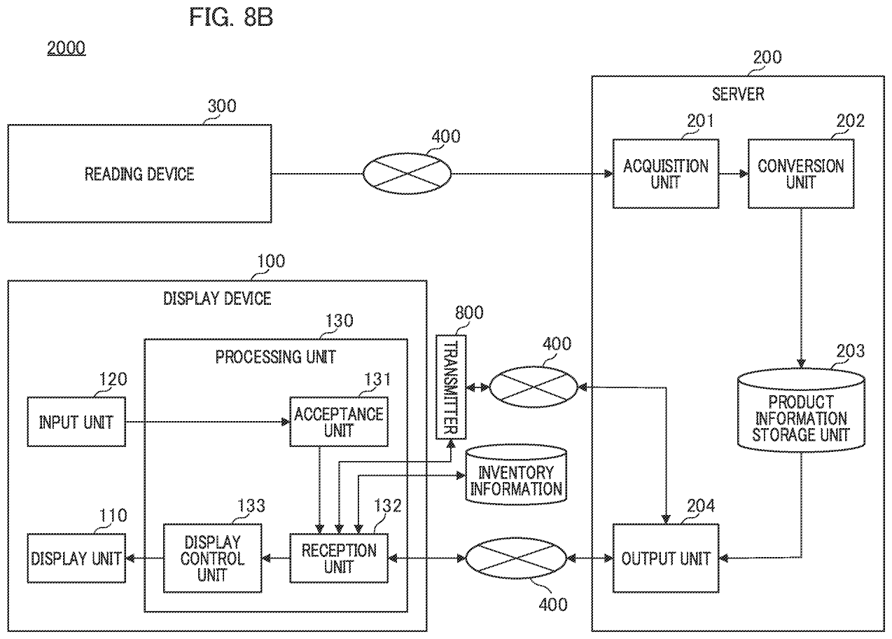

FIG. 8A is a schematic view illustrating a usage state of a transmitter 800 according to the second embodiment. As illustrated in FIG. 8A, the transmitter 800 (beacon) that functions as a device that transmits Bluetooth signals is installed at an entrance of a store. FIG. 8B is a schematic diagram illustrating the configuration of a guide system 2000 including the transmitter 800. The transmitter 800 may send a message directly to a smartphone, or the transmitter 800 may notify the server 200 that the smartphone is approaching, and the server 200 may deliver a message via the transmitter 800 when a user carrying a mobile terminal (display device 100), such as a smartphone that supports the Bluetooth (registered trademark) signal (search signal in this case) of the transmitter 800, approaches the entrance of the store. A reception unit 132 of the mobile terminal receives the message transmitted from the transmitter 800.

Note that the message here includes information for displaying the screens illustrated in FIGS. 6B and 7A. Specifically, included are thumbnails of product images illustrated in FIG. 6B, price information indicating their prices, link information of product position maps of respective products, and a product position map of each of the products. In this example, the product position maps (map illustrating the position of each product) of the respective products are embedded in the message in advance as images, and clicking a button 603 directly under a thumbnail of a product image in FIG. 6B results in displaying a product position map of a corresponding product as illustrated in FIG. 7A on the basis of link information associated with the button.

Note that the smartphone may be notified when the user merely approaches the store, or the notification message may be different depending on the distance from the store. For example, in a case where it is 50 m from the store (or if it is not detected to be in the vicinity of the store), it may be simply notified that they are on sale, or of information focusing on the main points such as the price of a featured product, whereas in a case where it is as close as 10 m from the store, more detailed information as illustrated in FIG. 6B may be notified.

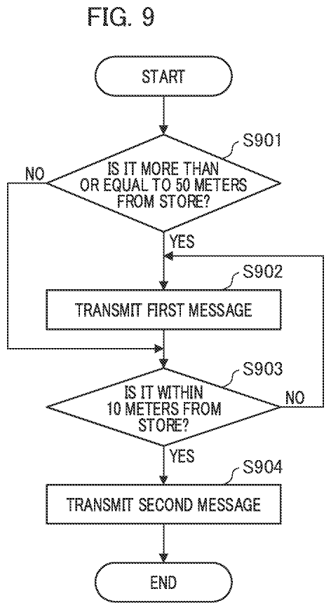

FIG. 9 is a flow chart illustrating an example of processing in the transmitter 800. In S901, the transmitter 800 determines whether or not the user's smartphone is farther than or equal to 50 m from the store. For this determination, for example, position information output by the global positioning system (GPS) function of the smartphone may be used. If the distance from the store is greater than or equal to 50 m (Yes), the transmitter 800 transmits, to the user's smartphone as a first message, for example information focusing on the main points such as that they are on sale or the price of a featured product (S902). On the other hand, if the distance from the store is not greater than or equal to 50 m (No in S901), the transmitter 800 determines whether or not the user's smartphone is within 10 m from the store in S903 and detects whether or not the user's smartphone is close to the store. If the distance from the store is less than 10 m (Yes), the transmitter 800 transmits, as a second message, more detailed information than the first message to the user's smartphone, for example as illustrated in FIG. 6B (S904). On the other hand, if the distance from the store is not less than 10 m (No in S903), the flow returns to S902, and the transmitter 800 transmits the first message to the user's smartphone.

As described above, according to the present embodiment, it is possible to facilitate a user to designate a product of which sales a store intends to promote.

The embodiment can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the embodiment of the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present application claims priority to Japanese Application No. 2019-237038, filed Dec. 26, 2019. The aforementioned application is hereby incorporated by reference herein.

What is claimed is:

1. A display device configured to display position information of a product on a basis of identification information including color information and size information of the product, the identification information being information of each product, and position information of a tag from which the identification information has been read, the display device comprising:
an acceptance unit configured to accept designation of a product from a user;
an acquisition unit configured to acquire position information associated with identification information of the product, designation of which by the user has been accepted by the acceptance unit; and
a display control unit configured to display a floor map and a position corresponding to the position information acquired by the acquisition unit on the floor map in an identifiable manner in accordance with designation from the user.

2. The display device according to claim 1, wherein
the acquisition unit acquires inventory information of the designated product, and
the display control unit displays a notification when stocks of the designated product is less than or equal to a threshold value.

3. The display device according to claim 1, wherein
the display device is a signage device installed in a store, and
the display control unit displays an installation position of the signage device on the floor map in an identifiable manner.

4. The display device according to claim 1, wherein
the display device is a mobile terminal, and
the acceptance unit accepts designation of the product by photographing the tag with a camera included in the mobile terminal.

5. The display device according to claim 1, wherein
the display device is a mobile terminal, and
the acceptance unit accepts designation of the product by the user selecting the product in an advertisement delivered to the mobile terminal.

6. A mobile terminal configured to display position information of a product on a basis of identification information of each product and position information of a tag from which information corresponding to the identification information has been read, the mobile terminal comprising:
a reception unit configured to receive a message transmitted from outside on a basis of detection of approach to a store by a device;
an acceptance unit configured to accept designation of one or more products from a plurality of products included in the message; and
a display unit configured to display a floor map displaying a position of the product, designation of which by a user has been accepted by the acceptance unit, in an identifiable manner.

7. A control method of a display device configured to display position information of a product on a basis of identification information including color information and size information of the product, the identification information being information of each product, and position information of a tag from which the identification information has been read, the control method comprising:
an acceptance step of accepting designation of a product from a user;
an acquisition step of acquiring position information associated with identification information of the product, designation of which by the user has been accepted in the acceptance step; and
a display step of displaying a floor map and. a position corresponding to the position information acquired in the acquisition step on the floor map in an identifiable manner in accordance with designation from the user.

8. A non-transitory computer readable storage medium that stores a program for causing a computer to execute the control method of the display device according to claim 7.

9. A control method of a mobile terminal configured to display position information of a product on a basis of identification information of each product and position information of a tag from which information corresponding to the identification information has been read, the control method comprising:
a reception step of receiving a message transmitted from outside on a basis of detection of approach to a store by a device;
an acceptance step of displaying a plurality of products included in the message and accepting designation of one or more products from the plurality of displayed products; and
a display step of displaying a floor map displaying a position of the product, designation of which by a user has been accepted in the acceptance step, in an identifiable manner.

10. A guide system comprising a server and a display device, wherein
the server comprises:
an acquisition unit configured to acquire identification information of each product read from a tag attached to each product by a reading device, the identification information including color information and size information of the product, and position information of the tag output from the reading device; and
an output unit configured to output the identification information acquired by the acquisition unit and the position information in association with each other, and
the display device comprises:
as acceptance unit configured to accept designation of a product from a user;
an acquisition unit configured to acquire position information associated with identification information of the product, designation of which by the user has been accepted by the acceptance unit; and
a display unit configured to display a floor map and a position corresponding to the position information acquired by the acquisition unit on the floor map in an identifiable manner in accordance with designation from the user.
